(19) United States
(12) Patent Application Publication
(10) Pub. No.: US 2023/0241680 A1
(43) Pub. Date: Aug. 3, 2023

(54) DEVICE AND METHOD OF OPERATION FOR A METAL DROP EJECTING THREE-DIMENSIONAL (3D) OBJECT PRINTER THAT FACILITATES REMOVAL OF SUPPORT STRUCTURES FROM A METAL OBJECT

(71) Applicant: Xerox Corporation, Norwalk, CT (US)

(72) Inventors: Joshua S. Hilton, Rochester, NY (US); Dinesh Krishna Kumar Jayabal, Cary, NC (US); Paul J. McConville, Webster, NY (US)

(21) Appl. No.: 17/649,393

(22) Filed: Jan. 31, 2022

(51) Int. Cl. B22F 10/22; B22F 12/53; B22F 12/00; B22F 10/40; B33Y 10/00; B33Y 30/00; B33Y 70/00

(52) U.S. Cl. CPC B22F 10/22; B22F 12/53; B22F 12/224; B22F 12/222; B22F 10/40; B33Y 10/00; B33Y 30/00; B33Y 70/00; B22F 2302/40

(57) ABSTRACT

A three-dimensional (3D) metal object manufacturing apparatus is equipped with a solid graphite application device that forms graphite interfaces between support structures and portions of the metal object supported by the support structures. The graphite forming the graphite interfaces are applied to support structures by operating an actuator to move the graphite application to a surface of the support structure and move a graphite member within the device against the surface of the support structure.

### TECHNICAL FIELD

This disclosure is directed to three-dimensional (3D) object printers that eject melted metal drops to form objects and, more particularly, to the formation of support structures for building a metal object in such printers.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers, while other technologies melt an elastomer and extrude the thermoplastic material into object layers. The printer typically operates one or more ejectors or extruders to form successive layers of plastic or thermoplastic material to construct a three-dimensional printed object with a variety of shapes and structures. After each layer of the three-dimensional printed object is formed, the plastic material is UV cured and hardens to bond the layer to an underlying layer of the three-dimensional printed object. This additive manufacturing method is distinguishable from traditional object-forming techniques, which mostly rely on the removal of material from a work piece by a subtractive process, such as cutting or drilling.

Recently, some 3D object printers have been developed that eject drops of melted metal from one or more ejectors to form 3D objects. These printers have a source of solid metal, such as a roll of wire or pellets, that feeds solid metal into a heated receptacle of a vessel in the printer where the solid metal is melted and the melted metal fills the receptacle. The receptacle is made of non-conductive material around which an electrical wire is wrapped to form a coil. An electrical current is passed through the coil to produce an electromagnetic field that causes the meniscus of the melted metal at a nozzle of the receptacle to separate from the melted metal within the receptacle and be propelled from the nozzle. A build platform is positioned to receive the ejected melted metal drops from the nozzle of the ejector and this platform is moved in a X-Y plane parallel to the plane of the platform by a controller operating actuators. These ejected metal drops form metal layers of an object on the platform and another actuator is operated by the controller to alter the distance between the ejector and the platform to maintain an appropriate distance between the ejector and the most recently printed layer of the metal object being formed. This type of metal drop ejecting printer is also known as a magnetohydrodynamic (MHD) printer.

Because the printing process performed with a MHD printer is executed on a drop-by-drop basis, it is capable of producing complex three-dimensional (3D) geometries that cannot be otherwise accomplished through traditional subtractive manufacturing techniques. Despite this advantage, a limit exists for the angles that can be used to form overhanging features on the object. In 3D metal printing, the previous layer of an object acts as a supporting base for the next printed layer. If the new layer steps beyond the previous layer at a right angle, such as a horizontal portion of a T-shaped part, the feature collapses because no supporting layer holds it for a sufficient period that enables the melted metal to freeze without drooping. Support structures that are not part of the object being formed can be produced to support the formation of an overhanging portion of the next object layer so complex shapes can be printed. As used in this document, the term “support structure” means an accumulation of ejected metal drops that supports ejected metal drops of object layers during object formation and is removed from the object after manufacture of the object.

Because the environment of a. 3D metal object material is a high temperature environment, for example, temperatures of 475° C. or higher are typically encountered, support structures of polymeric materials cannot he used. Instead, the same melted metal forming the object is also used to build the support structures. Because the object and the support are made of the same metal, the layers at the interface between the support and the object strongly bond to one another. This strong bond requires tools and machining to remove the support from the part. This type of support removal operation adds significant time, effort, and money to the 3D metal object manufacturing process. Being able to facilitating release of support structures after manufacture of metal object is complete without compromising the rigidity and endurance of the support in the high temperature environment would be beneficial.

### SUMMARY

A new method of operating a 3D metal object printer facilitates release of support structures after manufacture of metal object is complete without compromising the rigidity and endurance of the support in the high temperature environment. The method includes operating an ejector head to eject melted metal drops to form object layers and support layers that are supported by a member, and operating a graphite application device to form a graphite interface between a surface of a support structure formed with support layers and a surface of a portion of a metal object formed with object layers.

A new 3D metal object printer facilitates release of support structures after manufacture of metal object is complete without compromising the rigidity and endurance of the support in the high temperature environment. The new 3D metal object printer includes an ejector head having a vessel with a receptacle within the vessel that is configured to hold melted metal, a planar member, and a graphite application device that is configured to apply graphite to a surface to form a graphite interface between a support structure surface and a portion of a metal object being formed with melted metal drops ejected from the ejector head.

### BRIEF DESCRIPTION OF THE DRAWINGS

The foregoing aspects and other features of a method for operating a 3D metal object printer that facilitates release of support structures after manufacture of metal object is complete without compromising the rigidity and endurance of the support in the high temperature environment and a 3D metal object printer that implements the method are explained in the following description, taken in connection with the accompanying drawings.

FIG. 1A is a side view of a new 3D metal object printer that facilitates release of support structures after manufacture of metal object is complete without compromising the rigidity and endurance of the support in the high temperature environment.

FIG. 1B is a top view of the new 3D metal object printer shown in FIG. 1A.

FIG. 2A depicts an alternative embodiment of a new 3D metal object printer that facilitates release of support structures after manufacture of metal object is complete without compromising the rigidity and endurance of the support in the high temperature environment.

FIG. 2B is a top view of the new 3D metal object printer shown in FIG. 2A.

FIG. 3 is a schematic diagram of the graphite application device shown in FIG. 1A, FIG. 1B, FIG. 2A, and FIG. 2B.

FIG. 4 depicts a metal object, support structures, and interposed graphite layers formed by the printer of FIG. 1A and FIG. 2A.

FIG. 5 is a flow diagram of a process for operating the system of FIG. 1A or FIG. 2A that forms solid graphite interface layers that are interposed between object layers and support layers.

FIG. 6 is a schematic diagram of a prior art 3D metal printer that does not form support structures with solid graphite interface layers.

FIG. 7 is a schematic diagram of a prior art process for forming portions of a metal object separately from one another.

### DETAILED DESCRIPTION

For a general understanding of the environment for the 3D metal object printer and its operation as disclosed herein as well as the details for the printer and its operation, reference is made to the drawings. In the drawings, like reference numerals designate like elements.

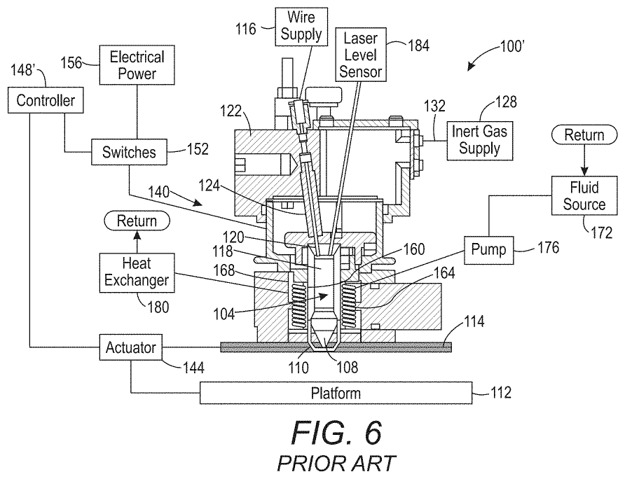

FIG. 6 illustrates an embodiment of a previously known 3D metal object printer 100 that ejects drops of a melted metal to form a metal object directly on a build platform. In the printer of FIG. 6, drops of melted bulk metal are ejected from a receptacle of a removable vessel 104 having a single nozzle 108 and drops from the nozzle form a base layer of an object with swaths applied directly to a build platform 112. As used in this document, the term “removable vessel” means a hollow container having a receptacle configured to hold a liquid or solid substance and the container as a whole is configured for installation and removal in a 3D metal object printer. As used in this document, the term “vessel” means a hollow container having a receptacle configured to hold a liquid or solid substance that may be configured for installation and removal from a 3D object metal printer. As used in this document, the term “bulk metal” means conductive metal available in aggregate form, such as wire of a commonly available gauge, pellets of macro-sized proportions, and metal powder.

With further reference to FIG. 6, a source of bulk metal 116, such as metal wire 120, is fed into a wire guide 124 that extends through the upper housing 122 in the ejector head 140 and melted in the receptacle of the removable vessel 104 to provide melted metal for ejection from the nozzle 108 through an orifice 110 in a baseplate 114 of the ejector head 140. As used in this document, the term “nozzle” means an orifice fluidically connected to a volume within a receptacle of a vessel containing melted metal that is configured for the expulsion of melted metal drops from the receptacle within the vessel. As used in this document, the term “ejector head” means the housing and components of a 3D metal object printer that melt, eject, and regulate the ejection of melted metal drops for the production of metal objects. A melted metal level sensor 184 includes a laser and a reflective sensor. The reflection of the laser off the melted metal level is detected by the reflective sensor, which generates a signal indicative of the distance to the melted metal level. The controller receives this signal and determines the level of the volume of melted metal in the removable vessel 104 so it can be maintained at an appropriate level 118 in the receptacle of the removable vessel. The removable vessel 104 slides into the heater 160 so the inside diameter of the heater contacts the removable vessel and can heat solid metal within the receptacle of the removable vessel to a temperature sufficient to melt the solid metal. As used in this document, the term “solid metal” means a metal as defined by the periodic chart of elements or alloys formed with these metals in solid rather than liquid or gaseous form. The heater is separated from the removable vessel to form a volume between the heater and the removable vessel 104. An inert gas supply 128 provides a pressure regulated source of an inert gas, such as argon, to the ejector head through a gas supply tube 132. The gas flows through the volume between the heater and the removable vessel and exits the ejector head around the nozzle 108 and the orifice 110 in the baseplate 114. This flow of inert gas proximate to the nozzle insulates the ejected drops of melted metal from the ambient air at the baseplate 114 to prevent the formation of metal oxide during the flight of the ejected drops. A gap between the nozzle and the surface on which an ejected metal drop lands is intentionally kept small enough that the inert gas exiting around the nozzle does not dissipate before the drop within this inert gas flow lands.

The ejector head 140 is movably mounted within Z-axis tracks for movement of the ejector head with respect to the platform 112 in a vertical direction. One or more actuators 144 are operatively connected to the base plate 114 to move the ejector head 140 along a Z-axis and one or more actuators 144 are operatively connected to the platform 112 to move the platform in an X-Y plane beneath the ejector head 140. The actuators 144 are operated by a controller 148 to maintain an appropriate distance between the orifice 110 in the baseplate 114 of the ejector head 140 and a surface of an object on the platform 112. The build platform in some versions of the system 100 consists essentially of oxidized steel, while in others the oxidized steel has an upper surface coating of tungsten or nickel. The oxidized steel version of the platform is not as likely to bond too strongly to the base layer of the melted aluminum since it is not readily wetted by melted aluminum. While this platform is advantageous for removal of the object after it is manufactured, it may not be adequately strong enough to support formation of the object during the entire process. To address this issue, other versions of the platform add tungsten or nickel surfaces to the platform to improve the wetting of the build surface with the melted aluminum.

Moving the platform 112 in the X-Y plane as drops of molten metal are ejected toward the platform 112 forms a swath of melted metal drops on the object being formed. Controller 148 also operates actuators 144 to adjust the distance between the ejector head 140 and the most recently formed layer on the substrate to facilitate formation of other structures on the object. While the molten metal 3D object printer 100 is depicted in FIG. 6 as being operated in a vertical orientation, other alternative orientations can be employed. Also, while the embodiment shown in FIG. 6 has a platform that moves in an X-Y plane and the ejector head moves along the Z axis, other arrangements are possible. For example, the actuators 144 can be configured to move the ejector head 140 in the X-Y plane and the platform 112 along the Z-axis, or they can be configured to move the ejector head 140 in both the X-Y plane and the Z-axis, or they can be configured to move the platform 112 in both the X-Y plane and Z-axis.

A controller 148 operates the switches 152. One switch 152 can be selectively operated by the controller to provide electrical power from source 156 to the heater 160, while another switch 152 can be selectively operated by the controller to provide electrical power from another electrical source 156 to the coil 164 for generation of the electrical field that ejects a drop from the nozzle 108. Because the heater 160 generates a great deal of heat at high temperatures, the coil 164 is positioned within a chamber 168 formed by one (circular) or more walls (rectilinear shapes) of the ejector head 140. As used in this document, the term “chamber” means a volume contained within one or more walls within a metal drop ejecting printer in which a heater, a coil, and a removable vessel of a 3D metal object printer are located. The removable vessel 104 and the heater 160 are located within such a chamber. The chamber is fluidically connected to a fluid source 172 through a pump 176 and also fluidically connected to a heat exchanger 180. As used in this document, the term “fluid source” refers to a container of a liquid having properties useful for absorbing heat. The heat exchanger 180 is connected through a return to the fluid source 172. Fluid from the source 172 flows through the chamber to absorb heat from the coil 164 and the fluid carries the absorbed heat through the exchanger 180, where the heat is removed by known methods. The cooled fluid is returned to the fluid source 172 for further use in maintaining the temperature of the coil in an appropriate operational range.

The controller 148 of the 3D metal object printer 100 requires data from external sources to control the printer for metal object manufacture. In general, a three-dimensional model or other digital data model of the object to be formed is stored in a memory operatively connected to the controller 148. The controller can selectively access the digital data model through a server or the like, a remote database in which the digital data model is stored, or a computer-readable medium in which the digital data model is stored. This three-dimensional model or other digital data model is processed by a slicer implemented with the controller to generate machine-ready instructions for execution by the controller 148 in a known manner to operate the components of the printer 100 and form the metal object corresponding to the model. The generation of the machine-ready instructions can include the production of intermediate models, such as when a CAD model of the device is converted into an STL data model, a polygonal mesh, or other intermediate representation, which in turn can be processed to generate machine instructions, such as g-code, for fabrication of the object by the printer. As used in this document, the term “machine-ready instructions” means computer language commands that are executed by a computer, microprocessor, or controller to operate components of a 3D metal object additive manufacturing system to form metal objects on the platform 112. The controller 148 executes the machine-ready instructions to control the ejection of the melted metal drops from the nozzle 108, the positioning of the platform 112, as well as maintaining the distance between the orifice 110 and a surface of the object on the platform 112.

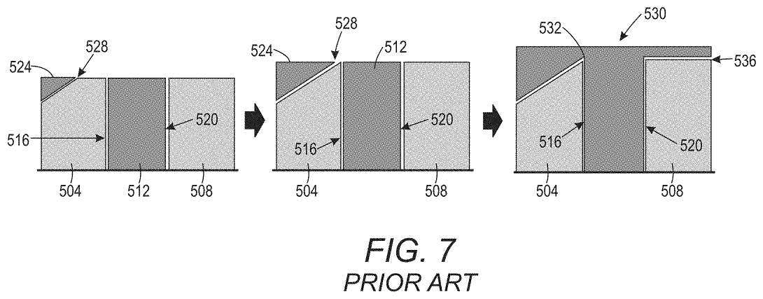

A prior art process for forming support structures with the printer of FIG. 6 is illustrated in FIG. 7. As shown in FIG. 7, some object features can be disconnected from the main body of the object at the beginning of the print and then joined to the main body as the print progresses. The process begins on the left side of the figure with the ejector head being operated to form supports 504 and 508 as well as object portion 512 in a layer-by-layer manner along the Z-axis or vertical direction. The interfaces 516 and 520 between the object portion 512 and the supports 504 and 508 are spatial voids so the supports and the object portion do not bond to one another. The formation of the supports and the object portion continues in the Z direction until a layer is reached that includes another object portion 524. The object/support interface 528 between this object portion and the support cannot be spatially void since the object portion 524 must rest on the support 504 so it can be properly formed. In the printer of FIG. 6, the respective layers of the support and object portion at this interface can bond so strongly that tools and machining are required to separate them from one another after the manufacture of the object is complete. The same is true regarding the interface 536 since the portion of the object overlying support 508 rests directly on the support. In the center portion of the process, the object portions 524 and 512 begin to converge and, as shown in the rightmost depiction, they meet at point 532. From this portion of the process onward, a single object layer is successively formed in the Z direction to complete the formation of the object.

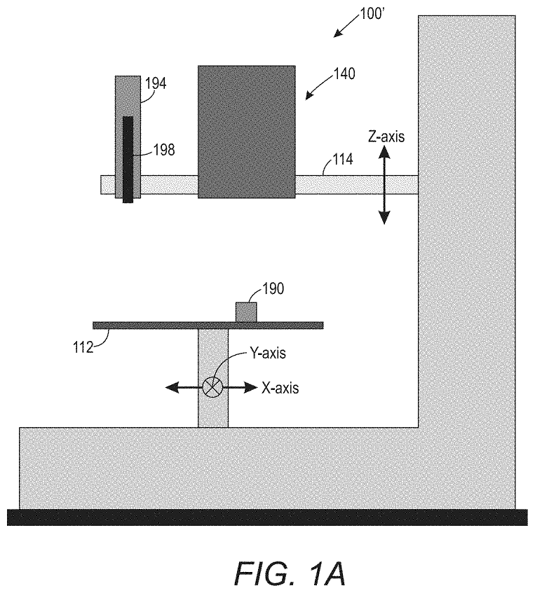

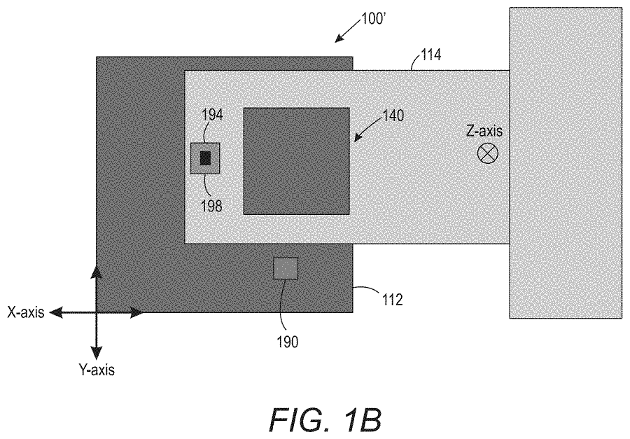

Using like reference numbers for like components and removing some of the components not used to stabilize the object during its formation, a new 3D metal object printer 100′ that forms support structures that are removed more easily is shown in FIG. 1A. The printer 100′ includes a graphite application device 194 that is mounted to the base plate 114 as well as a controller 148′ configured with programmed instructions stored in a non-transitory memory connected to the controller. The controller 148′ executes programmed instructions to operate the actuators 144 and the graphite application device 194 as described below to rub a graphite member 198 against a surface of a support structure before forming an object layer that is supported by or that contacts the support structure. The graphite layer transfers heat readily between the support structure and the object feature being supported. The ability to transfer heat is important because heat is transferred from the heated platform 112 to the object 190 being formed and the support structures to promote layer-to-layer adhesion and attenuate warping. After manufacture of the object is complete and the object has cooled, the support structure and the graphite layer can be easily broken away from the object because the graphite layer does not bond strongly to the object layer. As used in this document, the term “object layer” means a plane of a metal object formed with a plurality of melted metal drops having the same gravitational potential after they have landed that were ejected from the ejector head of a 3D metal object printer. As used in this document, the term “support layer” means a plane of a metal support structure formed with a plurality of melted metal drops having the same gravitational potential after they have landed that were ejected from the ejector head of a 3D metal object printer.

With further reference to FIG. 1A, the graphite application device 194 is mounted to the base plate 114 that holds the ejector head 140 so the same actuators 144 that move the base plate 114 and hence the ejector head 140 also moves the device 194. The heated build platform 112 is operatively connected to the actuators 144 so the platform can be moved in an X-Y plane beneath the base plate 114. In the embodiment shown in FIG. 1A, the Y-axis goes in and out of the plane of the figure while the X-axis moves to the left and right in the figure. Thus, the controller 148′ is configured with programmed instructions stored in a non-transitory memory operatively connected to the controller to cause the controller to operate some of the actuators 144 to move the graphite member 198 in the graphite application device 194 adjacent a support surface or an object surface and then move the device 194 to rub the graphite member 198 against the surface to apply graphite to the surface. A top view of the printer shown in FIG. 1A is provided in FIG. 1B.

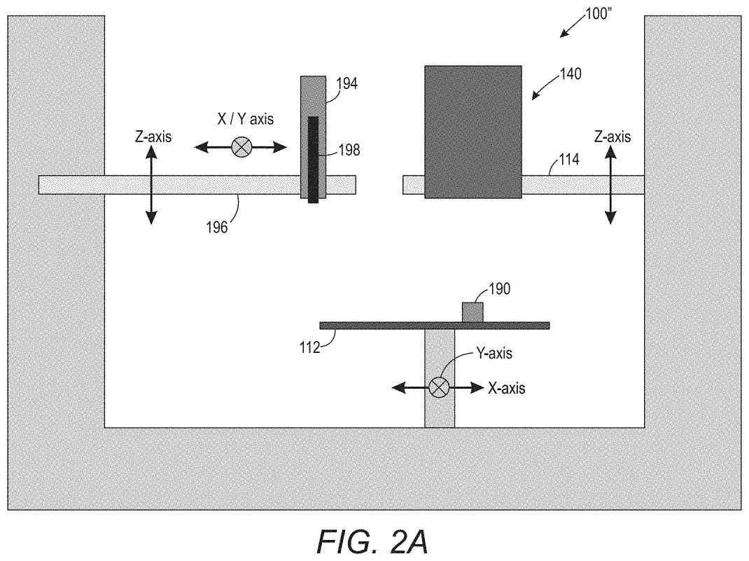

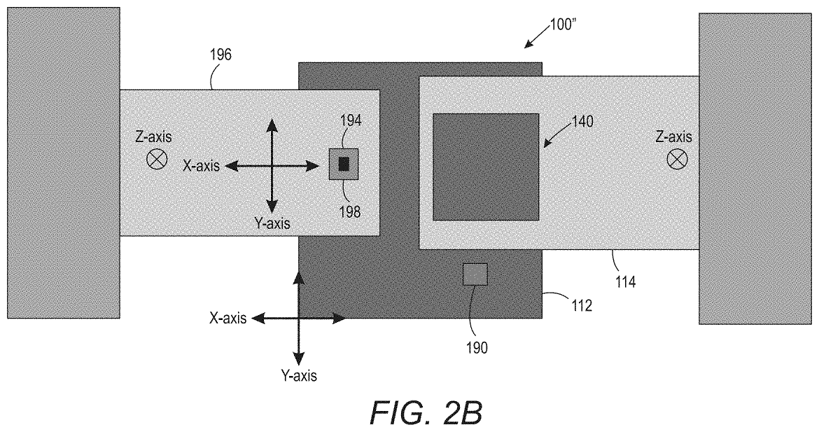

Using like reference numbers for like components, an alternative embodiment of a new 3D metal object printer 100′ that forms support structures that are removed more easily is shown in FIG. 2A. The printer 100″ includes a graphite application device 194 that is mounted to a member 196 that is configured to independent movement of the device 194 as well as a controller 148′ configured with programmed instructions stored in a non-transitory memory connected to the controller. The controller 148′ executes programmed instructions to operate the actuators 144 and the graphite application device 194 as described below to rub a graphite member 198 against a surface of a support structure before forming an object layer that is supported by or that contacts the support structure. The graphite layer transfers heat readily between the support structure and the object feature being supported. The ability to transfer heat is important because heat is transferred from the heated platform 112 to the object 190 being formed and the support structures to promote layer-to-layer adhesion and attenuate warping. After manufacture of the object is complete and the object has cooled, the support structure and the graphite layer can be easily broken away from the object because the graphite layer does not bond strongly to the object layer.

With further reference to FIG. 2A, the graphite application device 194 is mounted to the member 196 and member 196 is operatively connected to actuators 144 that are different than those that move the ejector head 140 so the device 194 and the ejector head 140 can be moved independently of one another. Some of the actuators are operatively connected to the member 196 to move the device in X-Y-Z space as shown in the figure. Thus, the controller 148′ is configured with programmed instructions stored in a non-transitory memory operatively connected to the controller to cause the controller to operate some of the actuators 144 to move the member 196 in the X-Y-Z space independently of the movement of platform 112 or the base plate 114 so the graphite member 198 in the graphite application device 194 can be moved adjacent a support surface or an object surface and then moved to rub the graphite member 198 against the surface to apply graphite to the surface. The heated build platform 112 is operatively connected to some of the actuators 144 so the platform can be moved in an X-Y plane beneath the base plate 114 while the base plate 114 is operatively connected to some of the actuators 144 for movement of the ejector head along the Z-axis in the vertical direction, although other configurations can be used as noted above. In the embodiment shown in FIG. 2A, the Y-axis goes in and out of the plane of the figure while the X-axis moves to the left and right in the figure. A top view of the printer shown in FIG. 1A is provided in FIG. 1B.

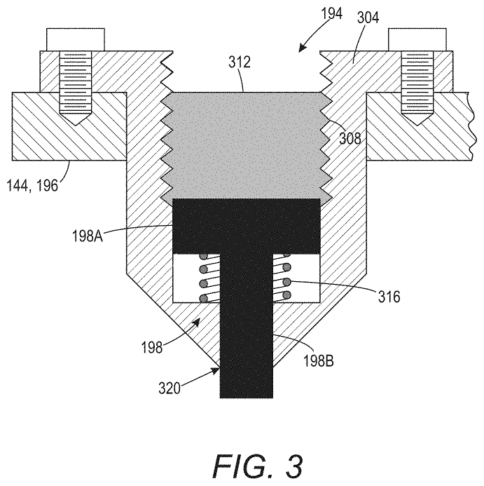

The application device 194 is shown in more detail in FIG. 3. The device 194 includes a housing 304 with a threaded recess 308. The graphite member 198 has a T-shaped cross-section with the upper cross-member 198A having a diameter that approximates the diameter of the opening in the housing 304. The extension 198B of the graphite member that is perpendicular to the upper cross-member 198A extends through orifice 320 of the housing 304. A spring 316 is concentrically mounted in the opening in the housing 304 and a threaded member 312 is screwed into the threaded recess 308 to interpose the upper cross-member 198A between the member 312 and the spring 316. The bias of the spring against the cross-member 198A and threaded member 312 keeps the graphite member 198 aligned in the orifice and stabilizes it during the rubbing of the graphite member 198 against a support or object surface to leave a layer of solid graphite. An actuator 144 is operatively connected to the threaded member 312 and configured to bidirectionally rotate the threaded member in the threaded recess 308 to advance the extension 198B as it is consumed during graphite application.

In one embodiment, the graphite member is made of solid graphite. As used in this document, the term “solid graphite” means a layer of graphite atoms on a surface that is applied to the surface with an abrasive, rubbing, or similar friction motion. As used in this document, the term “rub” means a non-circular frictional motion that applies solid graphite to a surface. As used in this document, the term “graphite application device” means an apparatus that transfers graphite from a solid graphite member to a surface against which the graphite member is rubbed. The thickness of the layer is 500 μm or less. The combination of the rubbing pressure and the asperity of the support surface or object surface facilitates the application of the solid graphite layer to the surface. The asperity or roughness of the support surface can be changed during the 3D printing process of forming the support structure by varying the spacing of the melted metal drops or the size of the drops in the last few layers of the support structure prior to application of the solid graphite layer.

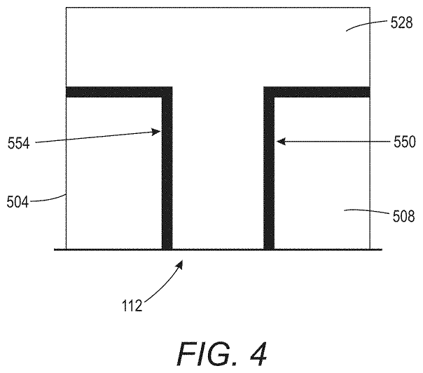

An example of a graphite layer between support structures and object portions is shown in FIG. 4. In that figure, portions of the object 528 are supported by support structures 504 and 508 with graphite interfaces 550, 554 interposed between them. Once the object manufacture is complete and the object has cooled, the support structures 504, 508 and the graphite interfaces 550, 554 can be easily removed by hand or with a lightweight gripping tool. As used in this document, the term “graphite interface” means a layer of graphite interposed between a portion of an object layer and a surface of a support structure that supports the portion of the object layer.

The controller 148′ can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During metal object formation, image data for a structure to be produced are sent to the processor or processors for controller 148′ from either a scanning system or an online or work station connection for processing and generation of the signals that operate the components of the printer 100′ to form an object on the platform 112.

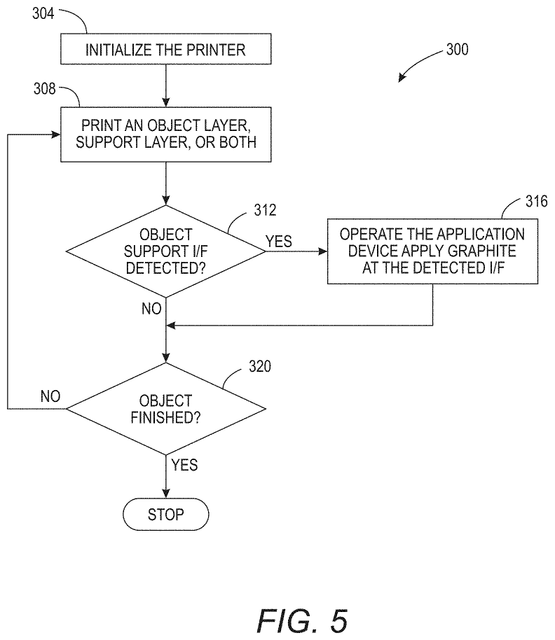

A process 300 for operating the 3D metal object printer 100′ to form solid graphite interfaces between portions of a metal object and the support structures for the manufacture of the object is shown in FIG. 5. In the description of the process, statements that the process is performing some task or function refers to a controller or general purpose processor executing programmed instructions stored in non-transitory computer readable storage media operatively connected to the controller or processor to manipulate data or to operate one or more components in the printer to perform the task or function. The controller 148′ noted above can be such a controller or processor. Alternatively, the controller can be implemented with more than one processor and associated circuitry and components, each of which is configured to form one or more tasks or functions described herein. Additionally, the steps of the method may be performed in any feasible chronological order, regardless of the order shown in the figures or the order in which the processing is described.

FIG. 5 is a flow diagram for a process 300 that operates the graphite application device 194 to form solid graphite interfaces between portions of a metal object and the support structures used to aid in the manufacture of the metal object with the printer 100′ and 100″. The controller 148′ is configured to execute programmed instructions stored in a non-transitory memory operatively connected to the controller to operate the application device 194 for this purpose. After the printer is initialized (block 304), the printer is operated to form an object layer and a support layer, if any (block 308). Prior to printing the next layer, the process determines whether an object layer/support layer interface is detected (block 312). If such an interface is detected, then the controller operates actuators to move the graphite application device into position for applying graphite and moves the device in a reciprocating manner to apply graphite to the interface area and form a graphite interface (block 316). When the area has been coated with the graphite, the process of forming object layers and support layers continues until the object is finished (block 320). Prior to performing the processing in block 316, the process can change the melted metal drop spacing or the melted metal drop size to increase the asperity of the support surface before forming the graphite interface.

The 3D metal object printer having the graphite application device and the method of operating such a printer provides a number of advantages not previously available. In previously known 3D metal object printers a tradeoff had to be considered for the robustness of the support structure. Since a support structure requires removal after the manufacturing process is complete, then the tendency was to make the support as lightweight as possible to facilitate its removal without requiring expensive machining and the like. This tendency, in some situations, produced a support structure inadequate to hold the extended object feature without drooping or the like. The graphite interfaces produced by the printer and method of operation disclosed above permits the formation of robust support structures that can be removed without machining. Also, the application of solid graphite is thought to be a significant advantage over the application of liquid suspensions of release materials to form breakaway interfaces between support structures and object features. The environment where the metal object is being formed is subject to high temperatures. The metal object and the support structure can be at temperatures of 475° C. and higher. A temperature drop as small as 15° C. can cause object feature defects. The transfer of solid graphite from the applicator to the support structure does not result in such temperature changes.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

1. A metal drop ejecting apparatus comprising:
an ejector head having a vessel with a receptacle within the vessel that is configured to hold melted metal, the ejector head being configured to eject drops of melted metal from the receptacle serially;
a planar member positioned opposite the ejector head; and
a graphite application device that is configured to apply graphite to a surface to form a graphite interface between a support structure surface formed with drops of melted metal ejected from the receptacle of the ejector head and a portion of a metal object being formed on the planar member with drops of melted metal ejected from the receptacle of the ejector head.

2. The apparatus of claim 1, the graphite application device further comprising:
a housing having an opening;
a graphite member within the opening of the housing;
a first actuator operatively connected to the housing; and
a controller operatively connected to the first actuator, the controller being configured to:
operate the first actuator to move the housing to the surface and move the graphite member with a reciprocating motion against the surface to form the graphite interface between the support structure formed with drops of melted metal ejected from the receptacle of the ejector head and the portion of the metal object being formed on the planar member with drops of melted metal ejected from the receptacle of the ejector head.

3. The apparatus of claim 2, the graphite application device further comprising:
a member in the opening of the housing;
a second actuator operatively connected to the member; and
the controller being operatively connected to the second actuator, the controller being further configured to:
operate the second actuator to move the graphite member within the opening in the housing to extend an end of the graphite member outside of the opening.

4. The apparatus of claim 3 further comprising:
a spring mounted within the opening in the housing about the graphite member;
wherein a portion of the graphite member is interposed between the member and the spring.

5. The apparatus of claim 4 further comprising:
a threaded recess in the opening of the housing; and
wherein the member within the opening of the housing is a threaded member and the second actuator is configured to rotate the threaded member in the threaded recess; and
the controller is further configured to:
operate the second actuator to rotate the threaded member in the threaded recess to extend the graphite member.

6. The apparatus of claim 5 wherein the graphite member has a T-shaped longitudinal cross-sectional area and a cross-member of the T-shaped graphite member is interposed between the threaded member and one end of the spring.

7. The apparatus of claim 3, the controller being operatively connected to the ejector head, the controller being further configured to:
operate the ejector head to change a spacing between the serially ejected melted metal drops that form the support structure surface.

8. The apparatus of claim 3, the controller being operatively connected to the ejector head, the controller being further configured to:
operate the ejector head to change a size of the serially ejected melted metal drops that form the support structure surface.

9. The apparatus of claim 2, the apparatus further comprising:
a member to which the ejector head and the housing are mounted; and
wherein the first actuator is operatively connected to the member so the operation of the first actuator moves the ejector head and the housing in tandem.

10. The apparatus of claim 2, the apparatus further comprising:
a first member to which the ejector head is mounted;
a second member to which the housing is mounted, the first member being different than the second member;
a second actuator operatively connected to the second member;
wherein the first actuator is operatively connected to the first member; and
the controller is operatively connected to the second actuator, the controller being configured to operate the first actuator and the second actuator to move the ejector head and the housing independently of one another.

11. The apparatus of claim 10, the controller is further configured to:
operate the second actuator to move the second member in three dimensional space.

12. The apparatus of claim 11, the controller is further configured to:
operate the first actuator to move the ejector head within a plane or along a single axis.

13-24. (canceled)
